(19) United States
(12) Patent Application Publication
(10) Pub. No.: US 2025/0286359 A1
(43) Pub. Date: Sep. 11, 2025

(54) ADDITIONAL COVER STRUCTURE FOR PHASE INSULATED MEDIUM VOLTAGE BUSBAR SYSTEMS

(71) Applicant: EAE ELEKTRIK ASANSOR ENDUSTRISI INSAAT SANAYI VE TICARET ANONIM SIRKETI, Esenyurt (TR)

(72) Inventor: Vedat VOSKI, Esenyurt (TR)

(21) Appl. No.: 18/815,977

(22) Filed: Aug. 27, 2024

(30) Foreign Application Priority Data
Mar. 7, 2024 (TR) 2024/002727

(51) Int. Cl. H02G 5/08

(52) U.S. Cl. CPC H02G 5/08

(57) ABSTRACT

Disclosed is an additional cover structure for phase insulated medium voltage busbar systems, which provides damping of the circulation currents occurring in the body of medium voltage busbar systems used in industrial facilities and factories.

### CROSS-REFERENCE TO RELATED APPLICATIONS

Not applicable.

### BACKGROUND OF THE INVENTION

The present invention relates to an additional cover structure for phase insulated medium voltage busbar systems.

The invention especially relates to an additional cover structure for phase insulated medium voltage busbar systems, which provides damping of the circulation currents occurring in the body of medium voltage busbar systems used in industrial facilities and factories.

Today, systems called busbars are used in energy distribution systems. Busbar systems contain conductors that carry current and voltage. Each conductor, called a busbar, is a structure capable of carrying current and voltage. Thanks to these systems, electrical energy is transported safely from one point to another.

Medium Voltage Busbar systems are used as channel energy distribution systems for energy transmission and distribution needs in high security buildings and facilities.

In existing phase-insulated medium voltage busbar structures, circulation currents occur in the body of the system. In some systems, the body must be grounded for this circulation current to occur.

In addition, the use of the system is dangerous because the formation of circulation currents causes an increase in temperature in the body and high current and voltage induction.

In the literature, US patent application numbered US2014014390, it is stated that “A buss bar assembly for a multiphase electrical machine, including a substantially annular dielectric housing having a central axis, a plurality of dielectric phase bar mounting members located within the housing, and a plurality of electrically conductive phase bars. The phase bars are disposed in the housing and substantially surround the central axis. Each phase bar has opposing, substantially planar axial sides and is in engagement with at least one phase bar mounting member. An axial side of each phase bar is in superposition with an axial side of another phase bar whereby the plurality of phase bars are axially stacked along the central axis. The phase bars have mutually spaced positions relative to each other in directions along the central axis, these positions defined by the phase bar mounting members whereby the phase bars are electrically isolated from each other within the housing.”

In said application the phase bars have mutually spaced positions relative to each other in directions along the central axis and these positions are defined by phase bar mounts. With this spacing, the phase rods are electrically isolated from each other within the housing.

In US patent application numbered US2023261445, it is stated that “A plug-on neutral (PON) device includes a housing that defines a phase cooperation portion configured to physically cooperate with phase buses of a bus assembly. The phase cooperation portion is configured to be electrically isolated from the phase buses and stabilize the PON device when installed on the bus assembly. A neutral cooperation portion is configured to physically cooperate with the neutral bus and to physically stabilize the PON device when installed. An electrical connector disposed at the neutral cooperation portion is configured to electrically connect to the neutral bus at an external end and to electrically connect to a conductive current path at its internal end. A lug assembly has one or more conductive terminal lugs, each terminal lug configured to receive current from an external neutral source via an aperture in the lug end of the housing and to electrically connect to the current path.”

In the said application, a pluggable neutral (PON) device is described for connecting to the neutral busbar of an electrical panel or a busbar assembly placed inside the panel.

Also, in the literature, U.S. Pat. No. 5,173,572A, it is stated that “An isolated phase busbar installation has a closed circulatory cooling system in which a deionization device is interconnected between the tubular enclosures of two isolated phase busbars of the installation between which air is caused to flow. The deionization device comprises an open-ended metal tubular housing which is connected to earth, and which has, extending transversely across the bore and dividing the bore throughout its length into a plurality of passages, a plurality of mutually spaced metal sheets. Each metal sheet has a plurality of transversely extending convolutions at spaced positions along the length of the housing so that each passage follows an undulating path. The number of metal sheets and the number and amplitude of the convolutions of each sheet and the dimensions of each passage having regard to the volume and velocity of air flowing from the tubular enclosure of one of said busbars through the tubular housing to the tubular enclosure of the other of said busbars are such that no contaminants are carried by flow of air from one tubular enclosure to the other.”

In the said patent, an isolated phase busbar installation of the type used to provide a permanent electrical connection between a generator and the generator transformer in the power station is disclosed.

Due to the reasons mentioned above, there is a need for additional cover structure for phase-insulated medium voltage busbar systems.

### SUMMARY OF THE INVENTION

Based on this state of the art, the aim of the invention is to introduce an additional cover structure for phase-insulated medium voltage busbar systems that eliminates the existing disadvantages.

Another aim of the invention is to provide a structure that provides natural damping of the high currents flowing through the phase body.

Another aim of the invention is to create a structure in which the circulation currents on the body are minimized.

Another aim of the invention is to provide a structure that allows natural damping of the circulation current by cross-connecting the phase bodies with insulated conductors at the joint point of phase-insulated medium voltage busbars.

Another aim of the invention is to create a structure that prevents the temperature increase in the busbar body due to the decrease in circulation currents.

### BRIEF DESCRIPTION OF DRAWINGS

FIG. 1 is a perspective view of the medium voltage busbar system that is the subject of the invention.

FIG. 2 is a perspective view of the additional cover structure in the medium voltage busbar system that is the subject of the invention.

FIG. 3 is another perspective view of the additional cover structure in the medium voltage busbar system that is the subject of the invention.

### REFERENCE NUMBERS

1. Conductive Busbar
2. Cast Resin
3. Additional Cover Connection Terminal
4. Busbar Body
5. Crossing Busbar
6. Insulation Material
7. Additional Cover

### DETAILED DESCRIPTION OF THE INVENTION

In this detailed description, preferred embodiments of the invention are described only for a better understanding of the subject and in a way that does not form any limiting effect.

The invention is an additional cover structure for phase-insulated medium voltage busbar systems that provides damping of the circulation currents occurring in the body of medium voltage busbar systems used in industrial facilities and factories. The invention consists of a conductive busbar (1), which enables the transmission of medium voltage and current. A busbar body (4) is positioned as a metal profile that surrounds each phase separately, contains a single conductor, and protects the busbar system against external influences. A cast resin (2) is formed as the insulation material to provide insulation between the said conductive busbar (1) and the metal busbar body (4), and comprises a crossing busbar (5), which allows 3 metal busbar bodies (4) to be crossed for the natural damping of circulation currents. An electrical insulation material (6) of a certain thickness that surrounds the crossing busbars (5) is used to prevent said crossing busbars (5) from touching each other. An additional cover (7) is positioned as a metal cover that carries the crossing busbars (5) covered with insulation material (6), protects them against external influences, and enables the busbar bodies (4) to be crossed at the joint point.

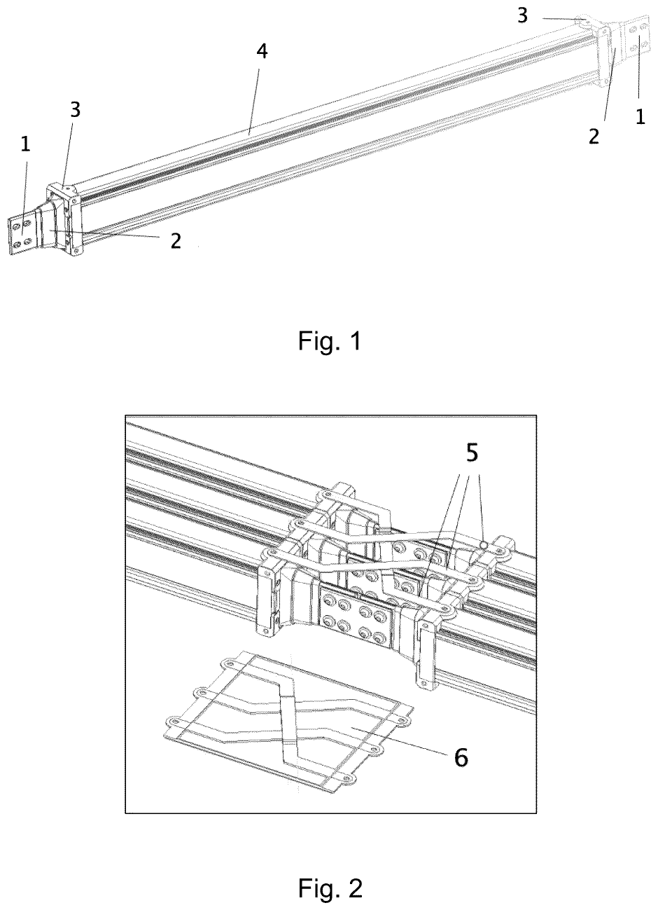

FIG. 1 shows a perspective view of the medium voltage busbar system that is the subject of the invention.

FIG. 2 shows a perspective view of the additional cover structure in the medium voltage busbar system that is the subject of the invention.

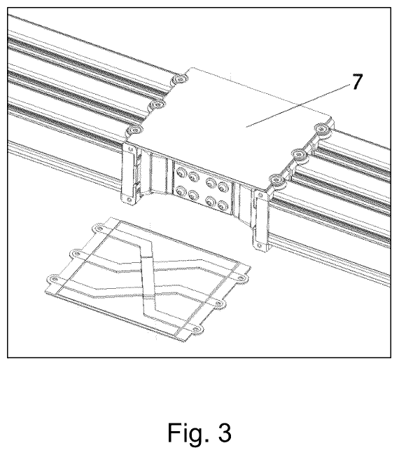

FIG. 3 shows another perspective view of the additional cover structure in the medium voltage busbar system that is the subject of the invention.

An additional cover structure in the medium voltage busbar system that is the subject of the invention, consists of a conductive busbar (1), which enables the transmission of medium voltage and current. A busbar body (4) is positioned as a metal profile that surrounds each phase separately, contains a single conductor, and protects the busbar system against external influences. A cast resin (2) is formed as the insulation material that provides insulation between the said conductive busbar (1) and the metal busbar body (4). A crossing busbar (5), which allows 3 metal busbar bodies (4) to be crossed for natural damping of circulation currents. An electrical insulation material (6) of a certain thickness that surrounds the crossing busbars (5) to prevent said crossing busbars (5) from touching each other. An additional cover (7) is positioned as a metal cover that carries the crossing busbars (5) covered with insulation material (6), protects them against external influences, and enables the busbar bodies (4) to be crossed at the joint point. An additional cover connection terminal (3) is positioned as a metal conductive part to ensure the contact of the metal phase busbar body (4) and also forms the bolt connection infrastructure to protect the additional covers (7) additional area against external influences.

In medium voltage busbars, the current and voltage passing through the conductive busbars (1) create circulation currents on the busbar body (4). In order to dampen the circulation currents, crossing busbars (5) insulated with insulation material (6) are positioned on the surface of an additional cover (7).

The said additional cover (7) is connected to the additional cover connection terminal (3) to dampen the currents on the busbar body (4).

The additional cover (7) that gave rise to the invention is a special application. The invention is related to an additional feature added to the additional cover structures used to protect the connected area after the phase-insulated high voltage busbar modules are added together. These covers only protected the joint area against external influences.

With our invention, thanks to the crossing busbars (5) insulated by the insulation material (6) and placed on this additional cover (7), natural damping of the circulation currents occurring between the busbar bodies (4) is also provided.

1. An additional cover structure for phase-insulated medium voltage busbar systems that provides damping of the circulation currents occurring in the body of medium voltage busbar systems used in industrial facilities and factories, the additional cover structure comprising:
a conductive busbar, which enables the transmission of medium voltage and current;
a busbar body, positioned as a metal profile that surrounds each phase separately, contains a single conductor, and protects the busbar system against external influences;
a cast resin, formed as the insulation material that provides insulation between the conductive busbar and the metal busbar body, and comprises a crossing busbar, which allows 3 metal busbar bodies to be crossed for natural damping of circulation currents, an electrical insulation material of a certain thickness that surrounds the crossing busbars to prevent said crossing busbars from touching each other, and an additional cover, positioned as a metal cover that carries the crossing busbars covered with insulation material, protects the crossing busbars against external influences, and enables the busbar bodies to be crossed at the joint point.

2. An additional cover structure according to the claim 1, further comprising an additional cover connection terminal, positioned as a metal conductive part to ensure the contact of the metal phase busbar body and to form the bolt connection infrastructure to protect the additional cover's additional area against external influences
